(19) United States
(12) Patent Application Publication
(10) Pub. No.: US 2023/0246180 A1
(43) Pub. Date: Aug. 3, 2023

(54) Positive Electrode for Lithium Secondary Battery and Lithium Secondary Battery Including the Same

(71) Applicant: LG Energy Solution, Ltd., Seoul (KR)

(72) Inventors: Chi Ho Jo, Daejeon (KR); Wang Mo Jung, Daejeon (KR); Hye Hyeon Kim, Daejeon (KR); Tae Gu Yoo, Daejeon (KR); Jin Tae Hwang, Daejeon (KR); Hae Jung Jung, Daejeon (KR); Jong Wook Heo, Daejeon (KR)

(73) Assignee: LG Energy Solution, Ltd., Seoul (KR)

(21) Appl. No.: 18/004,263

(22) PCT Filed: Jun. 2, 2022
(86) PCT No.: PCT/KR2022/007848

§ 371 Date: Jan. 5, 2023

(30) Foreign Application Priority Data
Jun. 3, 2021 (KR) 10-2021-0071877

(51) Int. Cl. H01M 4/505; H01M 4/04; H01M 4/587; H01M 4/131; H01M 4/1391; H01M 4/525; H01M 10/052; H01M 4/02

(52) U.S. Cl. CPC H01M 4/505; H01M 4/0404; H01M 4/587; H01M 4/131; H01M 4/1391; H01M 4/525; H01M 10/052; H01M 2004/028

(57) ABSTRACT

Provided are a positive electrode for a lithium secondary battery and a lithium secondary battery containing the same. The positive electrode includes a positive electrode current collector and a positive electrode mixture layer disposed thereon and includes a positive electrode active material, a positive electrode additive represented by Formula 1 (LiₚCo_{(1-q)}M¹_{q}O₄), a conductive material, and a binder. Furthermore, Equation 1 (R_{LCZO}/R₀) is 1.55 or less, wherein R_{LCO} represents an electrode sheet resistance when the positive electrode additive represented by Formula 1 is contained in the positive electrode mixture layer, and R₀ represents an electrode sheet resistance when the positive electrode additive represented by Formula 1 is not contained in the positive electrode mixture layer. The positive electrode is manufactured using a pre-dispersion containing the positive electrode additive in a positive electrode mixture layer as an irreversible additive.

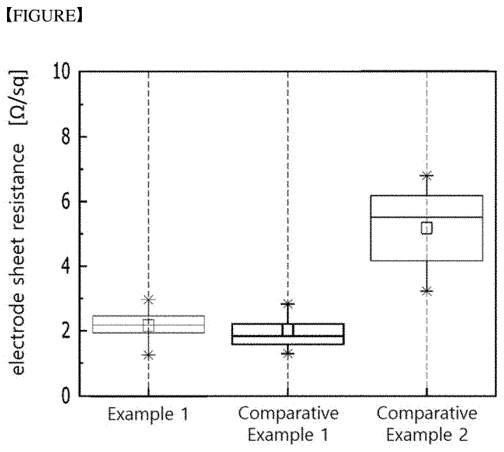

### CROSS-REFERENCE TO RELATED APPLICATIONS

This application is a national phase entry under 35 USC § 371 of International Application No. PCT/KR2022/007848, filed on Jun. 2, 2022, which claims priority from Korean Patent Application No. 10-2021-0071877, filed on Jun. 3, 2021, the disclosures of which are incorporated herein by reference in its entirety.

### TECHNICAL FIELD

The present invention relates to a positive electrode for a lithium secondary battery and a lithium secondary battery including the same.

### BACKGROUND

Recently, the demand for secondary batteries as an energy source is rapidly increasing. Among these secondary batteries, lithium secondary batteries that have a high energy density, a high operating potential, a long cycle life and a low self-discharging rate have been widely studied, commercialized and used in various fields.

Graphite is mainly used as a negative electrode material for a lithium secondary battery, but has a small capacity per unit mass of 372 mAh/g, so it is difficult to increase the capacity of a lithium secondary battery. Accordingly, a high capacity lithium secondary battery has been developed using a non-carbon negative electrode material having a higher energy density than graphite, such as a negative electrode material that forms an intermetallic compound with lithium, such as silicon, tin and their oxides. However, such a non-carbon-based negative electrode material has a large capacity but low initial efficiency, so there is a problem in that the amount of lithium composition during initial charging/discharging is large, and the irreversible capacity loss is large.

In this regard, a method for overcoming the irreversible capacity loss of a negative electrode was suggested using a material that can provide a lithium ion source or reservoir to a positive electrode material and electrochemically exhibit activity after the first cycle so as not to degrade the entire performance of a battery. Specifically, a method of applying an oxide containing an excess of lithium, for example, Li₆CoO₄, to the positive electrode as a sacrificial positive electrode material or an irreversible additive (or an overdischarge inhibitor) is known.

Meanwhile, a conventional irreversible additive such as Li₆CoO₄ is generally prepared by reacting a metal oxide such as cobalt oxide with excess lithium oxide. The irreversible additive prepared as described above is structurally unstable and generates a large amount of oxygen gas (O₂) as charging progresses, and in the initial charging of a secondary battery, that is, the activation of a battery, when the irreversible additive does not react completely and remains, a reaction in the subsequent charging/discharging process may occur, causing side reactions or generating a large amount of oxygen gas in the battery. The oxygen gas generated as described above may cause volume expansion of an electrode assembly, acting as one of the main factors causing the deterioration of battery performance.

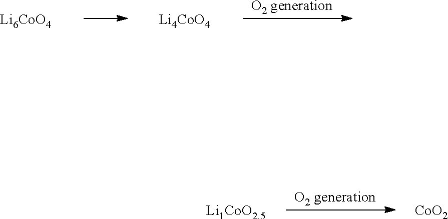

In addition, a typically used irreversible additive exhibits a very low powder electrical conductivity of up to 10⁻¹¹ S/cm, which is almost close to an insulator, due to a 2D percolating network. Such a low powder electrical conductivity increases the electrical resistance of the positive electrode. In this case, while a large capacity of 200 mAh/g or more is shown at a low C-rate, when the C-rate increases, as charging/discharging proceeds, performance is rapidly decreased due to a large resistance, so there is a limitation in that the charge/discharge capacity of the battery is decreased, and high-speed charging/discharging is difficult.

Accordingly, there is a demand for the development of a lithium secondary battery having excellent electrical performance as well as improved battery safety.

### RELATED ART DOCUMENT

### Patent Document

Korean Unexamined Patent Application Publication No. 10-2019-0064423

### Technical Problem

Therefore, the present invention is directed to providing a positive electrode for a lithium secondary battery, the positive electrode effectively improving the electrical properties of the lithium secondary battery and improving safety, and the present invention is further directed to a lithium secondary battery including the same.

### Technical Solution

To solve the above problems,

one aspect of the present invention provides a positive electrode for a lithium secondary battery, the positive electrode including:

a positive electrode current collector, and

a positive electrode mixture layer disposed on the positive electrode current collector, wherein the positive electrode mixture layer includes a positive electrode active material, a positive electrode additive represented by Formula 1 below, a conductive material and a binder,

LiₚCo_{(1-q)}M¹_{q}O₄ [Formula 1]

wherein,

M¹ is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and

p and q are 5≤p≤7 and 0≤q≤0.5, respectively;

wherein the following Equation 1 is satisfied with 1.55 or less:

R_{LCZO}/R₀ [Equation 1]

wherein,

R_{LCZO} represents an electrode sheet resistance when the positive electrode additive represented by Formula 1 is contained in the positive electrode mixture layer, and

R₀ represents an electrode sheet resistance when the positive electrode additive represented by Formula 1 is not contained in the positive electrode mixture layer.

Specifically, in the case of the positive electrode for a lithium secondary battery, Equation 1 may be 1.3 or less.

In addition, the positive electrode additive may have a tetragonal structure with a space group of P4₂/nmc.

Moreover, the content of the positive electrode additive may be 0.1 to 10 parts by weight with respect to 100 parts by weight of the positive electrode mixture layer.

In addition, the positive electrode active material may be a lithium metal composite oxide represented by Formula 2:

Liₓ[Ni_{y}Co_{z}Mn_{w}M²ᵥ]Oᵤ [Formula 2]

wherein,

M² is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and

x, y, z, w, v and u are 1.0≤x≤1.30, 0.1≤y<0.95, 0.01<z≤0.5, 0.01<w≤0.5, 0≤v≤0.2, and 1.5≤u≤4.5, respectively.

Moreover, the conductive material may include or be one or more selected from the group consisting of activated carbon, natural graphite, artificial graphite, carbon black, acetylene black, Denka Black, Ketjen black, Super-P, channel black, furnace black, lamp black, thermal black, graphene, and carbon nanotubes.

In addition, the conductive material may be included in an amount of 0.1 to 5 parts by weight with respect to 100 parts by weight of the positive electrode mixture layer.

In addition, another aspect of the present invention provides a method of manufacturing a positive electrode for a lithium secondary battery, the method including:

preparing a pre-dispersion by mixing a positive electrode additive represented by Formula 1 below, a conductive material and a binder;

preparing a positive electrode slurry by mixing the pre-dispersion, a positive electrode active material and the binder; and

forming a positive electrode mixture layer by applying the positive electrode slurry on the positive electrode current collector,

LiₚCo_{(1-q)}M¹_{q}O₄ [Formula 1]

In Formula 1,

M¹ is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and

p and q are 5≤p≤7 and 0≤q≤0.5, respectively;

wherein, in the case of the manufactured positive electrode, Equation 1 below is satisfied with 1.55 or less;

R_{LCZO}/R₀ [Equation 1]

wherein,

R_{LCZO} represents an electrode sheet resistance when the positive electrode additive represented by Formula 1 is contained in the positive electrode mixture layer, and

R₀ represents an electrode sheet resistance when the positive electrode additive represented by Formula 1 is not contained in the positive electrode mixture layer.

Here, the preparing of a pre-dispersion may be performed at a relative humidity of 10% or less.

Further, still another aspect of the present invention provides

a lithium secondary battery which includes the positive electrode according to the present invention; a negative electrode; and a separator disposed between the positive electrode and the negative electrode.

Here, the negative electrode may include a negative electrode current collector and a negative electrode mixture layer disposed on the negative electrode current collector, wherein the negative electrode mixture layer includes a negative electrode active material, wherein the negative electrode active material may contain a carbon material and a silicon material.

In addition, the silicon material may include one or more of silicon (Si) particles and silicon oxide (SiOx, 1≤x≤2) particles, and the silicon material may be included at 1 to 20 parts by weight with respect to 100 parts by weight of the negative electrode mixture layer.

### Advantageous Effects

A positive electrode for a lithium secondary battery according to the present invention is manufactured using a pre-dispersion containing the positive electrode additive represented by Formula 1 in a positive electrode mixture layer as an irreversible additive, and by adjusting the electrode sheet resistance ratio according to the use of the positive electrode additive to satisfy a specific range, there are advantages in that not only the amount of oxygen gas generated during charging/discharging can be reduced, but also the charging/discharging efficiency of the lithium secondary battery can be easily improved.

### BRIEF DESCRIPTION OF THE DRAWINGS

FIGURE is a graph illustrating the sheet resistances of the positive electrodes manufactured in Example 1, and Comparative Examples 1 and 2.

### DETAILED DESCRIPTION

The present invention may have various modifications and various examples, and thus specific examples are illustrated in the drawings and described in detail in the detailed description.

However, it should be understood that the present invention is not limited to specific embodiments, and includes all modifications, equivalents or alternatives within the spirit and technical scope of the present invention.

The terms “comprise,” “include” and “have” used herein designate the presence of characteristics, numbers, steps, actions, components or members described in the specification or a combination thereof, but it should be understood that these terms do not preclude the possibility of the presence or addition of one or more other characteristics, numbers, steps, actions, components, members or a combination thereof.

In addition, when a part of a layer, film, region or plate is disposed “on” another part, this includes not only a case in which one part is disposed “directly on” another part, but also a case in which still another part is interposed therebetween. In contrast, when a part of a layer, film, region or plate is disposed “under” another part, this includes not only a case in which one part is disposed “directly under” another part, but also a case in which still another part is interposed therebetween. In addition, in this application, “on” may include not only a case of disposed on an upper part but also a case of disposed on a lower part.

Moreover, the “main component” used herein may be a component contained at 50 wt % or more, 60 wt % or more, 70 wt % or more, 80 wt % or more, 90 wt % or more, 95 wt % or more, or 97.5 wt % or more with respect to the total weight of a composition or specific component, and in some cases, when the main component constitutes the entire composition or specific component, it may be contained at 100 wt %.

In addition, the term “Ah” as used herein refers to a capacity unit of a lithium secondary battery, and is also called “ampere hour,” meaning a current amount per hour. For example, when the battery capacity is “3000 mAh,” it means that a battery can be discharged with a current of 3000 mA for 1 hour.

Hereinafter, the present invention will be described in further detail.

Positive Electrode for Lithium Secondary Battery

In one embodiment of the present invention, a positive electrode for a lithium secondary battery includes:

a positive electrode current collector, and

a positive electrode mixture layer disposed on the positive electrode current collector and containing a positive electrode active material, a positive electrode additive, a conductive material and a binder.

The positive electrode for a lithium secondary battery according to the present invention includes a positive electrode mixture layer prepared by coating, drying and pressing a positive electrode slurry on a positive electrode current collector, and the positive electrode mixture layer has a configuration containing a positive electrode active material, a positive electrode additive, a conductive material and a binder.

Here, the positive electrode additive may be a lithium cobalt oxide represented by Formula 1 below:

LiₚCo_{(1-q)}M¹_{q}O₄ [Formula 1]

wherein,

M¹ is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and

p and q are 5≤p≤7 and 0≤q≤0.5, respectively.

The positive electrode additive may contain lithium in excess to provide lithium for lithium consumption caused by an irreversible chemical and physical reaction at a negative electrode upon initial charging, i.e., activation, thereby increasing charge capacity, reducing irreversible capacity, and improving lifetime characteristics.

Among positive electrode additives, the positive electrode additive represented by Formula 1 may have a higher content of lithium ions than a nickel-containing oxide that is commonly used in the art, and thus can replenish lithium ions lost through an irreversible reaction during the initial activation of the battery, so that the charge/discharge capacity of the battery can be significantly improved. In addition, compared to the iron and/or manganese-containing oxide(s) commonly used in the art, there is no side reaction caused by the elution of a transition metal during the charging/discharging of the battery, so excellent stability of the battery is exhibited. Examples of the lithium cobalt oxides represented by Formula 1 may include Li₆CoO₄, Li₆Co_{0.5}Zn_{0.5}O₄, and Li₆Co_{0.7}Zn_{0.3}O₄.

In addition, the lithium cobalt oxide represented by Formula 1 may have a tetragonal crystalline structure, and among the tetragonal crystal structures, may be included in a space group of P4₂/nmc having a twisted tetrahedral structure consisting of a cobalt element and an oxygen element. Since the positive electrode additive has a twisted tetrahedral structure consisting of a cobalt element and an oxygen element and thus is structurally unstable, when the positive electrode additive is used at 5 parts by weight with respect to 100 parts by weight of the positive electrode mixture layer in the manufacture of a positive electrode, side reactions with moisture or oxygen in the air may be caused in the mixing process of the positive electrode slurry. However, the present invention has an advantage in that side reactions of the positive electrode additive with moisture or oxygen in the air can be prevented by using a composition in which a positive electrode additive is pre-dispersed with a conductive material in the preparation of the positive electrode slurry.

Moreover, the positive electrode additive may be included in an amount of 0.1 to 10 parts by weight, and specifically, 0.1 to 8 parts by weight; 0.1 to 5 parts by weight; 1 to 10 parts by weight; 2 to 10 parts by weight; 5 to 10 parts by weight; 2 to 8 parts by weight; 3 to 7 parts by weight; or 4 to 5.5 parts by weight with respect to 100 parts by weight of the positive electrode mixture layer. In the present invention, by adjusting the content of the positive electrode additive within the above range, the decrease in charge/discharge capacity caused by insufficient supplementation of lithium ions lost by the irreversible reactions due to a low content of the positive electrode additive may be prevented, and it is possible to prevent a large amount of oxygen gas from being generated during the charging/discharging of the battery due to excess positive electrode additive.

Further, the positive electrode for a lithium secondary battery may exhibit a low electrode sheet resistance even when containing a positive electrode additive represented by Formula 1, and therefore, excellent performance may be realized during charging/discharging of the battery.

Specifically, irreversible additives generally used in the art have a significantly low electrical conductivity of approximately 10⁻¹¹ S/cm, so there is a problem in that the resistance imparted to the electrode during charging/discharging of the battery is high. However, even while including the positive electrode additive represented by Formula 1 in the positive electrode mixture layer, the positive electrode for a lithium secondary battery according to the present invention may exhibit a low sheet resistance in a predetermined range.

In one example, the positive electrode may satisfy Equation 1 below representing the ratio (R_{LCO}/R₀) of the electrode sheet resistance (R_{LCO}) of a positive electrode containing the positive electrode additive represented by Formula 1 to the electrode sheet resistance (R₀) of a positive electrode not containing the positive electrode additive represented by Formula 1 with a value of 1.55 or less, and specifically, 1.5 or less, 1.4 or less, 1.3 or less, 1.2 or less, 0.2 to 1.5; 0.5 to 1.5; 0.8 to 1.5; or 0.8 to 1.3:

R_{LCZO}/R₀ [Equation 1]

wherein,

R_{LCZO} represents an electrode sheet resistance when the positive electrode additive represented by Formula 1 is contained in the positive electrode mixture layer, and

R₀ represents an electrode sheet resistance when the positive electrode additive represented by Formula 1 is not contained in the positive electrode mixture layer.

Meanwhile, the positive electrode active material is a positive electrode active material enabling irreversible intercalation and deintercalation, and may include a lithium metal composite oxide represented by Formula 2 below as a main component:

Liₓ[Ni_{y}Co_{z}Mn_{w}M²ᵥ]Oᵤ [Formula 2]

wherein,

M² is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and

x, y, z, w, v and u are 1.0≤x≤1.30, 0.1≤y<0.95, 0.01<z≤0.5, 0.01<w≤0.5, 0≤v≤0.2, and 1.5≤u≤4.5, respectively.

The lithium metal composite oxide represented by Formula 2 is a composite metal oxide including lithium and nickel and may include one or more compounds selected from the group consisting of LiNi_{1/3}Co_{1/3}Mn_{1/3}O₂, LiNi_{0.8}Co_{0.1}Mn_{0.1}O₂, LiNi_{0.6}Co_{0.2}Mn_{0.2}O₂, LiNi_{0.9}Co_{0.05}Mn_{0.05}O₂, LiNi_{0.6}Co_{0.2}Mn_{0.1}Al_{0.1}O₂, LiNi_{0.6}Co_{0.2}Mn_{0.15}Al_{0.05}O₂, and LiNi_{0.7}Co_{0.1}Mn_{0.1}Al_{0.1}O₂.

In addition, the content of the positive electrode active material may be 85 to 95 parts by weight, 88 to 95 parts by weight, 90 to 95 parts by weight, 86 to 90 parts by weight, or 92 to 95 parts by weight, with respect to 100 parts by weight of the positive electrode mixture layer.

Moreover, the conductive material may be used to improve the electrical performance of the positive electrode, and a conductive material that is conventionally used in the art, may be applied, specifically, one or more selected from the group consisting of activated carbon, natural graphite, artificial graphite, carbon black, acetylene black, Denka Black, Ketjen black, Super-P, channel black, furnace black, lamp black, thermal black, graphene, and carbon nanotubes.

As an example, as the conductive material, carbon black or Denka Black may be used alone or in combination.

In addition, the conductive material may be included in an amount of 0.1 to 5 parts by weight, and specifically, 0.1 to 4 parts by weight; 2 to 4 parts by weight; 1.5 to 5 parts by weight; 1 to 3 parts by weight; 0.1 to 2 parts by weight; or 0.1 to 1 part by weight, with respect to 100 parts by weight of the positive electrode mixture layer.

In addition, the binder serves to adhere a positive electrode active material, a positive electrode additive and a conductive material to each other, and any binder that has the above function can be used without particular limitation. Specifically, one or more resins selected from the group consisting of a polyvinylidene fluoride-hexafluoropropylene copolymer (PVdF-co-HFP), polyvinylidene fluoride (PVdF), polyacrylonitrile, polymethylmethacrylate, and a copolymer thereof may be included in the binder. In one example, the binder may include polyvinylidene fluoride.

In addition, with respect to a total of 100 parts by weight of the positive electrode mixture layer, the binder may be included in an amount of 1 to 10 parts by weight, and specifically, 2 to 8 parts by weight, or 1 to 5 parts by weight.

Moreover, the average thickness of the positive electrode mixture layer is not particularly limited, but specifically, may be 50 to 300 μm, and more specifically, 100 to 200 μm; 80 to 150 μm; 120 to 170 μm; 150 to 300 μm; 200 to 300 μm; or 150 to 190 μm.

In addition, in the positive electrode, a material that has high conductivity without causing a chemical change in the battery may be used as a positive electrode current collector. For example, as the positive electrode collector, stainless steel, aluminum, nickel, titanium, or calcined carbon may be used, and in the case of aluminum or stainless steel, one that is surface treated with carbon, nickel, titanium or silver may also be used. In addition, the positive electrode current collector may have fine irregularities formed on a surface thereof to increase the adhesion of the positive electrode active material, and may be formed in various shapes such as a film, a sheet, a foil, a net, a porous body, a foam body, and a non-woven fabric body. Moreover, the average thickness of the current collector may be appropriately applied within 3 to 500 μm in consideration of the conductivity and total thickness of the positive electrode to be manufactured.

Method of Manufacturing Positive Electrode for Lithium Secondary Battery

Furthermore, one embodiment of the present invention provides a method of manufacturing a positive electrode for a lithium secondary battery, the method including:

preparing a pre-dispersion by mixing the positive electrode additive represented by Formula 1 below; a conductive material and a binder;

preparing a positive electrode slurry by mixing the pre-dispersion, a positive electrode active material and a binder; and

forming a positive electrode mixture layer by applying the positive electrode slurry on the positive electrode current collector,

LiₚCo_{(1-q)}M¹_{q}O₄ [Formula 1]

wherein,

M¹ is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and

p and q are 5≤p≤7 and 0≤q≤0.5, respectively;

wherein Equation 1 below is satisfied with 1.55 or less,

R_{LCZO}/R₀ [Equation 1]

wherein,

R_{LCZO} indicates an electrode sheet resistance when the positive electrode additive represented by Formula 1 is contained in the positive electrode mixture layer, and

R₀ indicates an electrode sheet resistance when the positive electrode additive represented by Formula 1 is not contained in the positive electrode mixture layer.

The method of manufacturing a positive electrode for a lithium secondary battery according to the present invention may include preparing a pre-dispersion by first mixing a positive electrode additive represented by Formula 1, a conductive material and a binder, preparing a positive electrode slurry by additionally mixing the pre-dispersion with a positive electrode active material and the binder, and forming a positive electrode mixture layer by applying the positive electrode slurry on a positive electrode current collector and drying the positive electrode slurry.

Here, the preparing of a pre-dispersion is a step of mixing a positive electrode additive, a conductive material and a binder, and may be performed by a conventional method used in the preparation of a slurry in the art. For example, the preparing of a pre-dispersion is performed by inputting each component into a homo mixer and stirring the resultant for 30 to 600 minutes at 1,000 to 5,000 rpm, and viscosity may be controlled by an additional solvent during the stirring. In one example, the pre-dispersion may be prepared by inputting the positive electrode additive represented by Formula 1, a conductive material and a binder to a homo mixer and injecting an N-methylpyrrolidone solvent while mixing the components at 3,000 rpm for 60 minutes to adjust a viscosity at 25±1° C. to 7,500±300 cps.

In addition, the preparing of a pre-dispersion may be performed at temperature and/or humidity condition(s) satisfying a specific range to prevent the structurally unstable positive electrode additive from being decomposed and/or damaged.

Specifically, the preparing of a pre-dispersion may be performed under a temperature of 40° C. or less, and more specifically, 10 to 40° C.; 10 to 35° C.; 10 to 30° C.; 10 to 25° C.; 10 to 20° C.; 15 to 40° C.; 20 to 40° C.; 15 to 35° C.; or 18 to 30° C.

In addition, the preparing of a pre-dispersion may be performed at a relative humidity (RH) of 10% or less, and more specifically, 9% or less, 8% or less, 7% or less, 6% or less, 5% or less, 4% or less, 3% or less, 2% or less, or 1% or less.

In the present invention, by controlling the temperature and/or humidity condition(s) in the preparation of a pre-dispersion as described above, it is possible to prevent a decrease in irreversible activity due to side reactions with moisture and/or oxygen in the air that may occur in the process of mixing the fine particle-type positive electrode additive with a conductive material, and realize a low sheet resistance of the positive electrode mixture layer.

Lithium Secondary Battery

Further, one embodiment of the present invention provides a lithium secondary battery, which includes

the above-described positive electrode according to the present invention, a negative electrode and a separator interposed between the positive electrode and the negative electrode.

The lithium secondary battery according to the present invention includes the above-described positive electrode of the present invention, and thus not only has a low amount of oxygen gas generated during charging/discharging, but also exhibits excellent charging/discharging performance.

The lithium secondary battery of the present invention has a structure including a positive electrode, a negative electrode, and a separator interposed between the positive electrode and the negative electrode.

Here, the negative electrode may be manufactured by coating, drying and pressing a negative electrode active material on a negative electrode current collector, and may further selectively include a conductive material, an organic binder polymer or an additive, like the positive electrode, as needed.

In addition, the negative electrode active material may include, for example, a carbon material and a silicon material. The carbon material refers to a carbon material including a carbon atom as a main component, and examples of these carbon materials may include a graphite having a perfectly layered crystalline structure such as a natural graphite, a soft carbon having a low crystalline layered crystalline structure (graphene structure; a structure in which hexagonal honeycomb planes of carbon are arranged in layers) and a hard carbon in which the above-described structures are mixed with amorphous parts, artificial graphite, expanded graphite, a carbon nanofiber, non-graphitizing carbon, carbon black, acetylene black, Ketjen black, a carbon nanotube, a fullerene, activated carbon, and graphene, and preferably, one or more selected from the group consisting of a natural graphite, artificial graphite and a carbon nanotube. More preferably, the carbon material includes natural graphite and/or artificial graphite and may include any one or more of carbon black and carbon nanotubes in addition to the natural graphite and/or artificial graphite. In this case, the carbon material may include 0.1 to 10 parts by weight, and more specifically, 0.1 to 5 parts by weight or 0.1 to 2 parts by weight of carbon black and/or carbon nanotubes with respect to a total of 100 parts by weight of the carbon material.

In addition, the silicon material is a particle including silicon (Si), which is a metal component, as a main component, and may include one or more of silicon (Si) particles and silicon oxide (SiO_{X}, 1≤X≤2) particles. In one example, the silicon material may include silicon (Si) particles, silicon monoxide (SiO) particles, silicon dioxide (SiO₂) particles, or a mixture thereof.

Moreover, the silicon material may have a form in which crystalline particles and amorphous particles are mixed, and the proportion of the amorphous particles may be 50 to 100 parts by weight, and specifically, 50 to 90 parts by weight; 60 to 80 parts by weight, or 85 to 100 parts by weight with respect to a total of 100 parts by weight of the silicon material. In the present invention, thermal stability and flexibility may be improved without degrading the electrical properties of an electrode by controlling the proportion of the amorphous particles included in the silicon material in the above range.

In addition, the silicon material contains a carbon material and a silicon material, and may be included in an amount of 1 to 20 parts by weight, and particularly, 5 to 20 parts by weight; 3 to 10 parts by weight; 8 to 15 parts by weight; 13 to 18 parts by weight; or 2 to 7 parts by weight with respect to 100 parts by weight of the negative electrode mixture layer.

In the present invention, an amount of lithium consumption and an irreversible capacity loss during the initial charging/discharging of the battery may be reduced and a charge capacity per unit mass may also be improved by adjusting the contents of the carbon material and the silicon material included in the negative electrode active material to the above range.

In one example, the negative electrode active material may include 95±2 parts by weight of graphite and 5±2 parts by weight of a mixture in which silicon monoxide (SiO) particles and silicon dioxide (SiO₂) particles are uniformly mixed with respect to 100 parts by weight of the negative electrode mixture layer. In the present invention, an amount of lithium consumption and an irreversible capacity loss during the initial charging/discharging of the battery may be reduced and a charge capacity per unit mass may also be improved by adjusting the contents of the carbon material and the silicon material included in the negative electrode active material to the above range.

In addition, the negative electrode mixture layer may have an average thickness of 100 to 200 μm, and specifically, 100 to 180 μm, 100 to 150 μm, 120 to 200 μm, 140 to 200 μm, or 140 to 160 μm.

Moreover, the negative electrode current collector is not particularly limited as long as it does not cause a chemical change in the battery and has high conductivity, and for example, copper, stainless steel, nickel, titanium, or calcined carbon may be used, in the case of copper or stainless steel, one whose surface is treated with carbon, nickel, titanium or silver may be used. In addition, the negative electrode current collector, like the positive electrode current collector, has fine irregularities on a surface to reinforce the adhesion of the negative electrode active material and may be formed in various shapes such as a film, a sheet, a foil, a net, a porous body, a foam body, and a non-woven fabric body. In addition, the average thickness of the negative electrode current collector may be suitably applied within 3 to 500 μm in consideration of the conductivity and total thickness of the negative electrode to be manufactured.

In addition, as the separator, an insulating thin film is used, which is interposed between a positive electrode and a negative electrode and has high ion permeability and mechanical strength. The separator is not particularly limited as long as it is conventionally used in the art, and specifically, a sheet or non-woven fabric made of chemically-resistant and hydrophobic polypropylene, glass fiber, or polyethylene may be used. In some cases, a composite separator in which a porous polymer base material such as a sheet or non-woven fabric coated with inorganic/organic particles by an organic binder polymer may be used. When a solid electrolyte such as a polymer is used as an electrolyte, the solid electrolyte may also serve as a separator. Moreover, the separator may have a pore diameter of 0.01 to 10 μm and a thickness of 5 to 300 μm on average.

Meanwhile, the positive electrode and the negative electrode may be wound in a jelly roll shape and accommodated in a cylindrical, prismatic or pouch-type battery, or accommodated in a pouch-type battery in a folding or stack-and-folding form, but the present invention is not limited thereto.

In addition, a lithium salt-containing electrolyte according to the present invention may consist of an electrolyte and a lithium salt, and as the electrolyte, a non-aqueous organic solvent, an organic solid electrolyte, or an inorganic solid electrolyte may be used.

As the non-aqueous organic solvent, for example, aprotic organic solvents such as N-methyl-2-pyrrolidone, ethylene carbonate, propylene carbonate, butylene carbonate, dimethyl carbonate, diethyl carbonate, γ-butyrolactone, 1,2-dimethyoxy ethane, tetrahydroxy franc, 2-methyl tetrahydrofuran, dimethyl sulfoxide, 1,3-dioxolane, formamide, dimethylformamide, dioxolane, acetonitrile, nitromethane, methyl formate, methyl citrate, phosphoric acid triester, trimethoxy methane, a dioxolane derivative, sulfolane, methyl sulfolane, 1,3-dimethyl-2-imidazolidinone, a propylene carbonate derivative, a tetrahydrofuran derivative, ether, methyl propionate, and ethyl propionate may be used.

As the organic solid electrolyte, for example, polymers such as a polyethylene derivative, a polyethylene oxide derivative, a polypropylene oxide derivative, a phosphoric acid ester polymer, poly alginate lysine, polyester sulfide, polyvinyl alcohol, polyvinylidene fluoride, and polymers including an ionic dissociation group may be used.

As the inorganic solid electrolyte, for example, a nitride, halide or sulfate of lithium such as Li₃N, LiI, Li₅Ni₂, Li₃N—LiI—LiOH, LiSiO₄, LiSiO₄—LiI—LiOH, Li₂SiS₃, Li₄SiO₄, Li₄SiO₄—LiI—LiOH, or Li₃PO₄—Li₂S—SiS₂ may be used.

The lithium salt is a material that is readily soluble in the non-aqueous electrolyte, and may be, for example, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, (CF₃SO₂)₂NLi, chloroborane lithium, lower aliphatic carboxylic acid lithium, lithium 4-phenylborate, or a lithium imide.

In addition, to improve charging/discharging characteristics and flame retardancy, for example, pyridine, triethylphosphite, triethanolamine, cyclic ether, ethylene diamine, n-glyme, hexamethylphosphoric acid triamine, a nitrobenzene derivative, sulfur, a quinone imine dye, N-substituted oxazolidinone, N, N-substituted imidazolidine, ethylene glycol dialkyl ether, an ammonium salt, pyrrole, 2-methoxy ethanol, or aluminum trichloride may be added to the electrolyte. In some cases, to impart non-flammability, a halogen-containing solvent such as carbon tetrachloride or ethylene trifluoride may be further included, and to improve high-temperature storage properties, carbon dioxide gas may be further included, and fluoro-ethylene carbonate (FEC) or propene sultone (PRS) may be also included.

### EXAMPLES

Hereinafter, the present invention will be described in further detail with reference to examples and an experimental example.

However, the following examples and experimental example merely illustrate the present invention, and the content of the present invention is not limited to the following examples and experimental example.

### Example 1. Manufacture of Positive Electrode for Lithium Secondary Battery

A pre-dispersion for manufacturing a positive electrode was prepared by injecting N-methylpyrrolidone into a homo mixer, inputting 5 parts by weight of a positive electrode additive Li₆Co_{0.7}Zn_{0.3}O₄; 2 parts by weight of a conductive material carbon black; and 1 part by weight of a binder PVdF with respect to 100 parts by weight of a positive electrode slurry solid content, and performing primary mixing at 2,000 rpm for 30 minutes. Here, in the preparation of the pre-dispersion, the temperature and humidity were adjusted to be 20 to 25° C. and 3%, respectively.

Subsequently, a positive electrode slurry for a lithium secondary battery was prepared by inputting 91 parts by weight of a positive electrode active material LiNi_{0.6}Co_{0.2}Mn_{0.2}O₂; and 1 part by weight of a binder PVdF, with respect to 100 parts by weight of the positive electrode slurry solid content, into a homo mixer containing the prepared pre-dispersion, and performing secondary mixing at 2,500 rpm for 30 minutes.

A positive electrode was manufactured by applying the prepared positive electrode slurry to one surface of an aluminum current collector, drying the slurry at 100° C., and rolling the resultant. Here, the total thickness of the positive electrode mixture layer was 130 μm, and the total thickness of the manufactured positive electrode was approximately 200 μm.

### Comparative Example 1. Manufacture of Positive Electrode for Lithium Secondary Battery

A positive electrode for a lithium secondary battery was manufactured in the same manner as in Example 1, except that the positive electrode additive used in Example 1 was not used.

### Comparative Example 2. Manufacture of Positive Electrode for Lithium Secondary Battery

A positive electrode slurry for a lithium secondary battery was prepared by injecting N-methylpyrrolidone into a homo mixer, inputting 91 parts by weight of a positive electrode active material LiNi_{0.6}Co_{0.2}Mn_{0.2}O₂; 5 parts by weight of a positive electrode additive Li₆Co_{0.7}Zn_{0.3}O₄; 2 parts by weight of a conductive material carbon black; and 2 parts by weight of a binder PVdF with respect to 100 parts by weight of a positive electrode slurry solid content, and mixing them at 2,000 rpm for 60 minutes. Here, during the mixing, the temperature and humidity were adjusted to be 20 to 25° C. and 3%, respectively.

A positive electrode was manufactured by applying the prepared positive electrode slurry to one surface of an aluminum current collector, drying the slurry at 100° C., and rolling the resultant. Here, the total thickness of the positive electrode mixture layer was 130 μm, and the total thickness of the manufactured positive electrode was approximately 200 μm.

### Comparative Example 3. Manufacture of Positive Electrode for Lithium Secondary Battery

A pre-dispersion for manufacturing a positive electrode was prepared by injecting N-methylpyrrolidone into a homo mixer, inputting 5 parts by weight of a positive electrode additive Li₆Co_{0.7}Zn_{0.3}O₄; and 1 part by weight of a binder PVdF, and mixing them at 2,000 rpm for 30 minutes. Here, during the preparation of the pre-dispersion, the temperature and humidity were adjusted to be 20 to 25° C. and 3%, respectively.

Subsequently, a positive electrode slurry for a lithium secondary battery was prepared by inputting 91 parts by weight of a positive electrode active material LiNi_{0.6}Co_{0.2}Mn_{0.2}O₂; 2 parts by weight of a conductive material carbon black; and 1 part by weight of a binder PVdF, into a homo mixer containing the prepared pre-dispersion, and performing secondary mixing at 2,500 rpm for 30 minutes.

A positive electrode was manufactured by applying the prepared positive electrode slurry to one surface of an aluminum current collector, drying the slurry at 100° C., and rolling the resultant. Here, the total thickness of the positive electrode mixture layer was 130 μm, and the total thickness of the manufactured positive electrode was approximately 200 μm.

### Comparative Examples 4 and 5. Manufacture of Positive Electrode for Lithium Secondary Battery

A positive electrode for a lithium secondary battery was manufactured in the same manner as in Example 1, except that the temperature and the humidity were adjusted as shown in Table 1 below during the preparation of a pre-dispersion.

TABLE 1

| | Temperature | | Relative humidity |
|---|---|---|---|
| Comparative | 50 | ° C. | 3% |
| Example 4 | | | |
| Comparative | 20~25 | ° C. | 50% |
| Example 5 | | | |

### Example 2 and Comparative Examples 6 to 10. Manufacture of Lithium Secondary Battery

Natural graphite and silicon (SiOx, 1≤x≤2) particles as negative electrode active materials; and styrene butadiene rubber (SBR) as a binder were prepared, and a negative electrode slurry was prepared in the same manner as preparing the positive electrode slurry above. Here, the graphite used in preparation of a negative electrode mixture layer was natural graphite (average particle diameter: 0.01 to 0.5 μm), and silicon (SiOx) particles had an average particle diameter of 0.9 to 1.1 μm. A negative electrode was manufactured by coating one surface of a copper current collector with the prepared negative electrode slurry and drying and rolling the resultant at 100° C. Here, the total thickness of the negative electrode mixture layer was 150 μm, and the total thickness of the manufactured negative electrode was approximately 250 μm.

A full cell was manufactured by stacking a separator (thickness: approximately 16 μm) consisting of a porous polyethylene (PE) film between the negative electrode and one of the positive electrodes manufactured in Example 1 and Comparative Examples 1 to 5 and injecting E2DVC as an electrolyte. Table 2 below shows batteries prepared in Example 2 and Comparative Examples 6-10 corresponding to positive electrodes prepared in Example 1 and Comparative Examples 1-5.

Here, the “E2DVC” refers to a type of carbonate-based electrolyte, which is a mixed solution in which lithium hexafluorophosphate (LiPF₆, 1.0M) and vinyl carbonate (VC, 2 wt %) are added to a mixture of ethylene carbonate (EC):dimethyl carbonate (DMC):diethyl carbonate (DEC)=1:1:1 (volume ratio).

TABLE 2

| Positive electrode for lithium | Lithium |
|---|---|
| secondary battery | secondary battery |
| Example 1 | Example 2 |
| Comparative Example 1 | Comparative Example 6 |
| Comparative Example 2 | Comparative Example 7 |
| Comparative Example 3 | Comparative Example 8 |
| Comparative Example 4 | Comparative Example 9 |
| Comparative Example 5 | Comparative Example 10 |

### EXPERIMENTAL EXAMPLES

In order to evaluate the performance of the positive electrode for a lithium secondary battery according to the present invention, the following experiment was performed.

a) Evaluation of Electrode Sheet Resistance

The sheet resistance of each of the positive electrodes manufactured in Example 1 and Comparative Examples 1 to 5 was measured by a 4-point probe method, and the result is shown in Table 3 below and FIGURE.

b) Evaluation of Amount of Oxygen Gas Degassed During Charging/Discharging

Initial charging (formation) was carried out at 55° C. under conditions of 3.5V and 1.0C t for the lithium secondary batteries manufactured in Example 2 and Comparative Examples 6 to 10, and the content of oxygen gas generated during the initial charging was analyzed by degassing a gas generated from the positive electrode while the initial charging was performed. Then, by repeating charging/discharging 50 times at 45° C. under a 0.3C condition, the content of oxygen gas was further analyzed at each charging/discharging. The analyzed result is shown in Table 3 below.

c) Evaluation of Charge/Discharge Capacity and Retention Rate

Each of the lithium secondary batteries manufactured in Example 2 and Comparative Examples 6 to 10 was charged up to a charge termination voltage of 4.2 to 4.25 V with a charging current of 0.1C at 25° C. and activated. Subsequently, the secondary battery was discharged to a discharge termination voltage of 2V with a discharging current of 0.1C, and an initial charge/discharge capacity per unit mass was measured.

Afterward, the secondary battery was repeatedly charged/discharged 50 times at 45° C. under 0.3C to measure capacity during charging/discharging, and after performing charging/discharging 50 times, a charge/discharge capacity retention rate was calculated. The result is shown in Table 3 below.

TABLE 3

| | | | Amount of oxygen gas | | | |
|---|---|---|---|---|---|---|
| | | | generation [ml/g] | | Initial | |
| | Electrode resistance | | 1^{st} | 50^{th} | charging/ | Capacity |
| | Measured value | | charging/ | charging/ | discharge | retention |
| | [Ω/sq] | R_{LCZO}/R₀ | discharging | discharging | capacity [Ah] | rate |
| Example 2 | 2.4 ± 0.25 | [symbol] 1.2 | 86 | 12 | 103.2 | 92.5% |
| Comparative | 2.0 ± 0.1 | | 20 | 14 | 98.3 | 88.8% |
| Example 6 | | | | | | |
| Comparative | 5.5 ± 0.5 | [symbol] 2.75 | 116 | 40 | 100.1 | 89.1% |
| Example 7 | | | | | | |
| Comparative | 3.2 ± 0.02 | [symbol] 1.6 | 91 | 19 | 101.8 | 88.9% |
| Example 8 | | | | | | |
| Comparative | 3.4 ± 0.1 | [symbol] 1.7 | 101 | 68 | 100.6 | 86.5% |
| Example 9 | | | | | | |
| Comparative | 3.3 ± 0.02 | [symbol] 1.65 | 107 | 78 | 99.5 | 85.7% |
| Example 10 | | | | | | |

Referring to Table 3 and FIGURE, in the case of the positive electrode for a lithium secondary battery of the example manufactured according to the present invention, despite containing the positive electrode additive represented by Formula 1 in the positive electrode mixture layer, the sheet resistance of the electrode was so low that there was no significant difference from the sheet resistance (R₀) of the positive electrode not containing a positive electrode additive and the R_{LCZO}/R₀ value was less than 1.5. The lithium secondary battery of the example including this had not only a high initial charge/discharge capacity of 102 Ah or more, but also had a high capacity retention rate of 91% or more. In addition, it was confirmed that the lithium secondary battery had high safety as the amount of oxygen gas generated after initial charging/discharging was significantly reduced.

From the above result, the positive electrode for a lithium secondary battery according to the present invention was manufactured using a pre-dispersion containing the positive electrode additive represented by Formula 1 in the positive electrode mixture layer as an irreversible additive, and by adjusting the electrode sheet resistance ratio according to the use of the positive electrode additive to satisfy a specific range, there were advantages in that not only the amount of oxygen gas generated during charging/discharging was reduced, but also the charging/discharging efficiency of the lithium secondary battery was easily improved.

In the above, the present invention has been described with reference to exemplary embodiments, but it should be understood by those skilled in the art or those of ordinary skill in the art that the present invention can be variously modified and changed without departing the spirit and technical scope of the present invention described in the accompanying claims.

Accordingly, the technical scope of the present invention is not limited to the content described in the detailed description of the specification, but should be defined by the claims.

1. A positive electrode for a lithium secondary battery, the positive electrode comprising:
a positive electrode current collector, and
a positive electrode mixture layer disposed on the positive electrode current collector, wherein the positive electrode mixture layer comprises a positive electrode active material, a positive electrode additive represented by Formula 1 below, a conductive material and a binder,
LiₚCo_{(1-q)}M¹_{q}O₄ [Formula 1]
wherein,
M¹ is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and
p and q are 5≤p≤7 and 0≤q≤0.5, respectively,
wherein the following Equation 1 is 1.55 or less:
R_{LCZO}/R₀ [Equation 1]
wherein,
R_{LCZO} represents an electrode sheet resistance when the positive electrode additive represented by Formula 1 is comprised in the positive electrode mixture layer, and
R₀ represents an electrode sheet resistance when the positive electrode additive represented by Formula 1 is not comprised in the positive electrode mixture layer.

2. The positive electrode of claim 1, wherein Equation 1 is 1.3 or less.

3. The positive electrode of claim 1, wherein the positive electrode additive has a tetragonal structure with a space group of P4₂/nmc.

4. The positive electrode of claim 1, wherein the content of the positive electrode additive is 0.1 to 10 parts by weight with respect to 100 parts by weight of the positive electrode mixture layer.

5. The positive electrode of claim 1, wherein the positive electrode active material is a lithium metal composite oxide represented by Formula 2:
Liₓ[Ni_{y}Co_{z}Mn_{w}M²ᵥ]Oᵤ [Formula 2]
wherein,
M² is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and
x, y, z, w, v and u are 1.0≤x≤1.30, 0.1≤y<0.95, 0.01<z≤0.5, 0.01<w≤0.5, 0≤v≤0.2, and 1.5≤u≤4.5, respectively.

6. The positive electrode of claim 1, wherein the conductive material includes one or more selected from the group consisting of activated carbon, natural graphite, artificial graphite, carbon black, acetylene black, Denka Black, Ketjen black, Super-P, channel black, furnace black, lamp black, thermal black, graphene, and carbon nanotubes.

7. The positive electrode of claim 6, wherein the conductive material is comprised in an amount of 0.1 to 5 parts by weight with respect to 100 parts by weight of the positive electrode mixture layer.

8. A method of manufacturing a positive electrode for a lithium secondary battery, the method comprising:
preparing a pre-dispersion by mixing a positive electrode additive represented by Formula 1 below, a conductive material and a binder;
preparing a positive electrode slurry by mixing the pre-dispersion, a positive electrode active material and the binder; and
forming a positive electrode mixture layer by applying the positive electrode slurry on a positive electrode current collector,
LiₚCo_{(1-q)}M¹_{q}O₄ [Formula 1]
wherein,
M¹ is one or more elements selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and
p and q are 5≤p≤7 and 0≤q≤0.5, respectively,
wherein, Equation 1 below is satisfied with 1.55 or less:
R_{LCZO}/R₀ [Equation 1]
wherein,
R_{LCZO} represents an electrode sheet resistance when the positive electrode additive represented by Formula 1 is comprised in the positive electrode mixture layer, and
R₀ represents an electrode sheet resistance when the positive electrode additive represented by Formula 1 is not comprised in the positive electrode mixture layer.

9. The method of claim 8, wherein the preparing of a pre-dispersion is performed at a relative humidity of 10% or less.

10. A lithium secondary battery comprising the positive electrode of claim 1, a negative electrode, and a separator located between the positive electrode and the negative electrode.

11. The lithium secondary battery of claim 10, wherein the negative electrode comprises:
a negative electrode current collector; and
a negative electrode mixture layer disposed on the negative electrode current collector, wherein the negative electrode mixture layer comprises a negative electrode active material,
wherein the negative electrode active material comprises a carbon material and a silicon material.

12. The lithium secondary battery of claim 11, wherein the silicon material comprises one or more of silicon (Si) particles and silicon oxide (SiOx, 1≤x≤2) particles.

13. The lithium secondary battery of claim 11, wherein the silicon material is comprised in an amount of 1 to 20 parts by weight with respect to 100 parts by weight of the negative electrode mixture layer.
